(19) United States
(12) Patent Application Publication
(10) Pub. No.: US 2011/0185878 A1
(43) Pub. Date: Aug. 4, 2011

(54) Reed guard

(76) Inventor: Charles J. Nelson, Taylors, SC (US)

(21) Appl. No.: 12/658,063

(22) Filed: Feb. 2, 2010

(51) Int. Cl. G10B 3/00

(52) U.S. Cl. 84/363

(57) ABSTRACT

A reed guard assembly is provided that may include a mouthpiece and a bracket configured for engaging the mouthpiece. A reed may be held by the bracket against the mouthpiece. A reed guard may also be provided and can be configured for being placed into a guarded position to protect a at least a portion of the reed from damage. The reed guard may be capable of being pivoted with respect to the mouthpiece from the guarded position.

### FIELD OF THE INVENTION

The present invention relates generally to a reed guard for use in protecting a reed of a musical instrument. More particularly, the present application involves a reed guard assembly for use with a musical instrument that has a reed guard that may pivot and/or be attached to a mouthpiece when in both a guarded and an unguarded position.

### BACKGROUND

Musical instruments commonly employ reeds that engage the lips of the musician while playing the musical instrument. Reeds are typically held onto the mouthpiece of the musical instrument by way of a bracket. The reed itself is a fairly fragile component of the musical instrument and can be easily cracked, chipped, split or otherwise damaged. Damage to the reed may result upon the musician bumping the reed into an object while holding but not actually playing the musical instrument. Additionally, reeds may be damaged during transport of the musical instrument or even through storage. As such, a device capable of protecting a reed from damage that is easy to use and can be quickly and easily located would be desirable.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a perspective view of a reed guard assembly in a guarded position in accordance with one exemplary embodiment.

FIG. 2 is a perspective view of the reed guard assembly of FIG. 1 shown in an unguarded position.

FIG. 3 is a side view of the reed guard assembly of FIG. 1 in a guarded position.

FIG. 4 is a side view of the reed guard assembly of FIG. 1 in an unguarded position.

FIG. 5 is a side view of a reed guard assembly in an unguarded position in accordance with another exemplary embodiment.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a reed guard assembly 10 for use in protecting a reed 24 of a musical instrument. The reed guard assembly 10 may be attached to a mouthpiece 12 of the musical instrument and can be moved between a guarded position in which the reed 24 is protected to an unguarded position in which the reed 24 is not protected. The unguarded position may afford the musician with access to the reed 24 so as to be able to play the musical instrument. The reed guard 26 may be attached to the mouthpiece 12 in both the guarded position and the unguarded position so that one does not misplace or lose the reed guard 26 or otherwise be burdened by finding a location to store the reed guard 26 during use of the musical instrument.

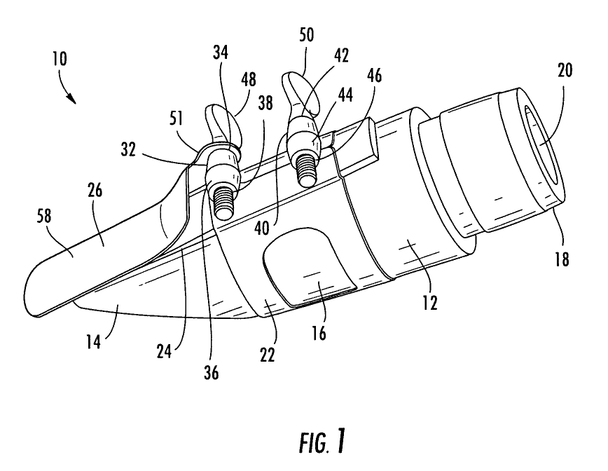

FIG. 1 illustrates one exemplary embodiment of a reed guard assembly 10. The reed guard assembly 10 is shown in a guarded position in which it protects a portion of a reed 24 from damage. The reed guard assembly 10 includes a reed guard 26 that may be made of a strong material such as metal or plastic that functions to prevent the reed 24 from being chipped, split, or otherwise damaged. The reed guard 26 can be placed over a portion 28 of the reed 24 to prevent this portion 28 from being damaged. As such, the reed guard 26 need not protect the entire reed 24 but need only protect a part of the reed 24 from damage in certain arrangements. The reed guard assembly 10 may include a bracket 22 that is attached to a mouthpiece 12 of a musical instrument. The mouthpiece 12 can include a tip 14, a middle section 16, and a tail 18 positioned such that the middle section 16 is between the tip 14 and the tail 18. The user may contact the tip 14 during use, and the tail 18 can be attached to a subsequent portion of the musical instrument. An air duct 20 may extend through the mouthpiece 12 so as to extend through the tip 14, middle section 16, and tail 18 thus forming openings on the tip 14 and tail 18.

The bracket 22 can be attached to the mouthpiece 12 in a variety of manners and may be present in order hold the reed 24 to the mouthpiece 12. In the exemplary arrangement shown, the bracket 22 can include a first protrusion 32 with a first aperture 34 that aligns with a second aperture 38 of a second protrusion 36. One or both of the first and second protrusions 32 and/or 36 can have internal threading formed therein so as to accept a thumb screw 48 that may be disposed through the apertures 34 and 38. The bracket 22 may further include a third protrusion 40 that defines a third aperture 42 that is in alignment with a fourth aperture 46 of a fourth protrusion 44. One or both of the third and/or fourth protrusions 40 can be provided with internal threading so as to receive and hold a second thumb screw 50. The user may tighten thumb screws 48 and 50 so as to effect a clamping of the bracket 22 to the middle section 16 of the mouthpiece 12. The reed 24 may be located between the bracket 22 and the outer surface of the mouthpiece 12 and may thus be held onto the mouthpiece 12 through clamping forces applied by the bracket 22 to the mouthpiece 12. Although described as using a pair of thumb screws 48 and 50 to effect attachment, it is to be understood that the bracket 22 may be attached through use of only one of the thumb screws 48 or 50 in other arrangements, and that yet further exemplary embodiments are possible in which thumb screws 48 and 50 are not used to effect attachment. In this regard, the bracket 22 may be attached by various methods such as but not limited to screws, bolts, clips, or frictional engagements.

The reed guard 26 may have an elongated portion 58 that can be variously shaped. For example, the elongated portion 58 may have a flat upper surface and a flat lower surface. Alternatively, the elongated portion 58 may have a concave lower surface and a convex upper surface in certain exemplary embodiments. The elongated portion 58 may extend from a mounting bracket 51 that is used to effect attachment of the reed guard 26 to the bracket 22. The mounting bracket 51 can extend upwards from the elongated portion 58 so that the mounting bracket 51 extends at an angle to the elongated portion 58 and is situated at a height that is greater than the height of the elongated portion 58. The mounting bracket 51 may have a mounting bracket aperture 52 defined therethrough. The mounting bracket aperture 52 can be oriented with respect to the bracket 22 so that it is aligned with both the first aperture 34 and the second aperture 38. The thumb screw 48 may be disposed through the mounting bracket aperture 52, the first aperture 34 and the second aperture 38. The thumb screw 48 can be tightened in order to secure and fix the position of the mounting bracket 51 and hence the reed guard 26 with respect to the bracket 22. With such an arrangement, forces imparted onto the reed guard 26 may be transferred through the first and second protrusions 32 and 36 and into the mouthpiece 12 without being transferred to and hence damaging the reed 24. The mounting bracket aperture 52 can be positioned between the first and second apertures 34 and 38 in other arrangements, or may be positioned on the side of the second aperture 38 so that the second aperture 38 is between the first aperture 34 and the mounting bracket aperture 52. The thumb screw 48 may engage the mounting bracket 51 or may not physically contact the mounting bracket 51 in various arrangements. Further, although described as being connected through use of the thumb screw 48, the mounting bracket 51 can be attached to the third and fourth protrusions 40 and 44 through the use of the second thumb screw 50 in manners similar to those described with respect to the thumb screw 48, first aperture 34, and second aperture 38 in other exemplary embodiments. Other features can be incorporated into the pivotal connection between the reed guard 26 and the bracket 22. For example, a spring can be incorporated into the connection so as to bias the reed guard 26 to a desired position. Also, one or more stop members can be supplied so as to limit the pivotal range of the reed guard 26 with respect to the bracket 22. In this regard, a stop member can be provided to prevent the reed guard 26 from being moved into contact with the reed 24. Further, a stop member can be arranged so as to limit the pivotal rotation of the reed guard 26 to prevent the reed guard 26 from contacting the mouthpiece 12 or third and fourth protrusions 42 and 46.

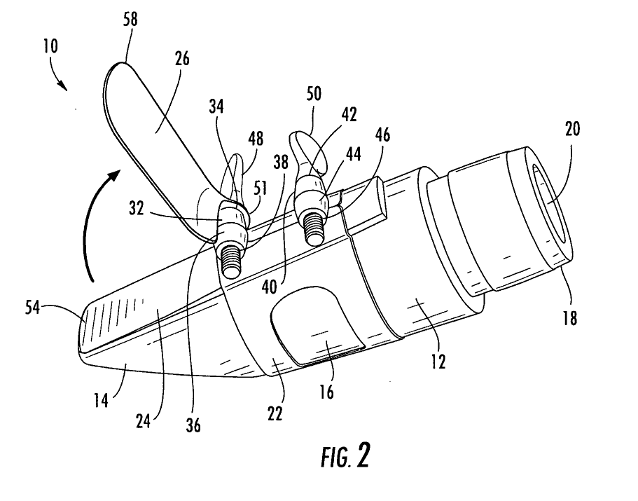

The mounting bracket 51 and hence the reed guard 26 may be pivotally mounted to the bracket 22 through the aforementioned engagement. The user may maintain the reed guard 26 in the guarded position when not using the musical instrument in order to protect the reed 24 from damage. When the user desires to use the reed 24 to play the musical instrument, the user may loosen the thumb screw 48 so as to remove clamping forces applied to the mounting bracket 51. The user may then rotate the reed guard 26 into an unguarded position as shown for example with reference to FIG. 2. The reed guard 26 can thus be pivoted about the thumb screw 48 into a position that affords the user access to the reed 24 so that the reed guard 26 will not interfere with the playing of the musical instrument. Once positioned into the unguarded position, the user may once again tighten the thumb screw 48 in order to apply clamping forces to the mounting bracket 51 and lock the reed guard 26 into the unguarded position. The reed guard 26 can thus be moved between the guarded and unguarded positions as desired depending upon whether the user wants to protect the reed 24 or play the musical instrument. The reed guard 26 may remain attached to the mouthpiece 12 and/or bracket 22 when in the unguarded position so that the user does not have to determine where to store the reed guard 26 as would be the case if the reed guard 26 were removable. However, it is to be understood that other arrangements of the reed guard assembly 10 are possible in which the reed guard 26 may in fact be removable from the mouthpiece 12 and/or bracket 22.

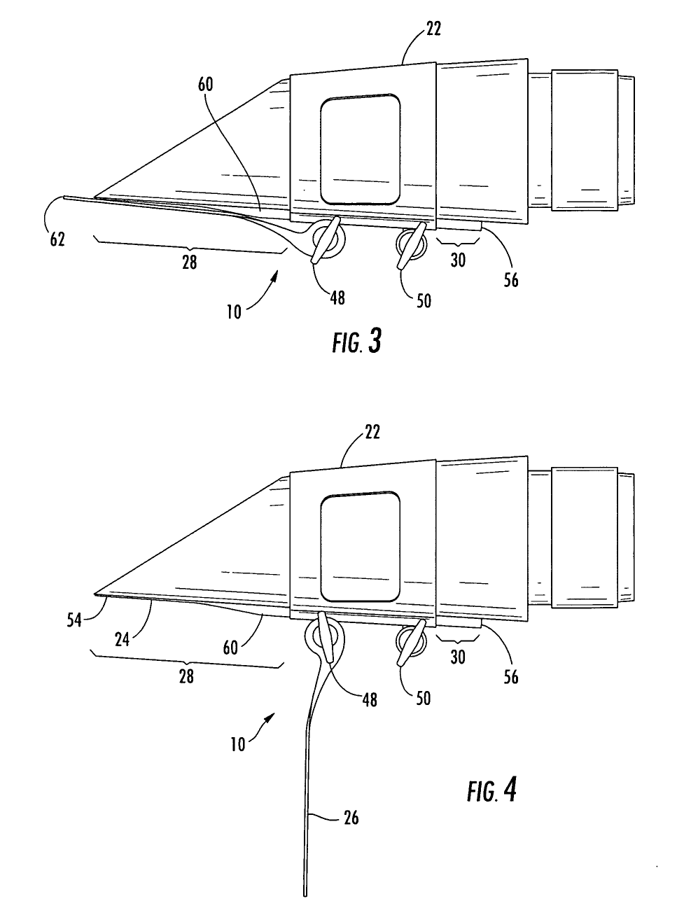

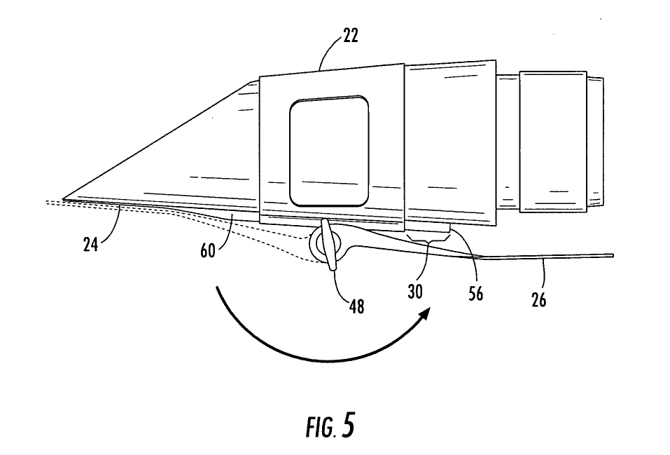

FIGS. 3 and 4 are side views of the reed guard assembly 10 shown in FIGS. 1 and 2. The reed guard 26 protects a portion of the reed 28 that extends from the bracket 22 to the end 54 of the reed 24 that is proximate to the tip 14 of the mouthpiece 12. The elongated portion 58 of the reed guard 26 may have a length sufficient to extend beyond the end 54 of the reed 24. As shown, an end 62 of the reed guard 26 extends beyond the end 54 of the reed 24 when the reed guard 26 is in the guarded position. This arrangement may help to protect the end 54 of the reed 24 from damage. With reference now to FIGS. 1 and 2, the reed guard 26 may have a width that is wider than the width of the reed 24 so as to cover the top of reed 24 and prevent same from being damaged. However, other arrangements are possible in which the width of the reed guard 26 is the same as or less than the width of the reed 24. The elongated portion 58 of the reed guard 26 may be arranged so that it does not cover the sides 60 of the reed 24. As shown with reference to FIG. 3, the reed guard 26 does not curve downwards so as to cover the side 60 of reed 24 such that the side 60 is still visible in the figure. However, other arrangements are possible in which the reed guard 26 will be shaped so as to cover some of all of the sides 60 of the reed 24 when in the guarded position.

The reed guard 26 may contact the reed 24 when in the guarded position. However, other arrangements are possible in which the reed guard 26 does not contact the reed 24 when in the guarded position but instead remains some distance spaced from the reed 24. However, the reed guard 26 will still be positioned so as to afford protection to the reed 24 even though the reed guard 26 does not contact the reed 24.

The reed 24 can include a portion 30 that extends from the bracket 22 to an end 56 of the reed 24 that is located proximate to the tail 18 of the mouthpiece 12. Portion 30 is not covered by the bracket 22 or by the reed guard 26 in the guarded and unguarded positions. As such, in the unguarded position, the reed guard 26 does not extend back to the portion 30 or beyond the end 56 such that the reed guard 26 if farther from the tail 18 than the end 56 or portion 30. FIG. 5 illustrates an alternative exemplary embodiment of the reed guard assembly 10 in which the reed guard 26 may be arranged so as to be able to extend backwards beyond the end 56 or portion 30 when in the unguarded position. The reed guard 26 may be located closer to the tail 18 than end 56 when in the unguarded position. Further, the reed guard 26 may contact the middle section 16 and/or tail 18 of the mouthpiece 12 when in the unguarded position. The reed guard 26 may thus be capable of rotating 180 degrees with respect to the mouthpiece 12 from the guarded to the unguarded position. This arrangement may prevent the reed guard 26 from interfering with the line of sight of the user when playing the musical instrument. However, it is to be understood that the reed guard assembly 10 may be arranged so that the reed guard 26 is capable of pivoting up to 90 degrees, up to 120 degrees, from 10 to 45 degrees, from 60 to 135 degrees, or up to 240 degrees with respect to the mouthpiece 12 from the guarded to the unguarded position in accordance with various exemplary embodiments.

Although described as protecting a portion of the reed 24 and not the whole reed 24, it is to be understood that other arrangements of the reed guard assembly 10 are possible in which the reed guard 26 protects the entire reed 24 when in the guarded position. In other embodiments, the reed guard 26 may protect greater than 50 percent of the length of the reed 24 or may protect less than 50 of the length of the reed 24.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A reed guard assembly for a musical instrument, comprising:
a mouthpiece having a tip, a middle section, and a tail, wherein an air duct is defined through the mouthpiece that extends from the tip through the middle section to the tail;
a bracket configured for engaging the mouthpiece;
a reed held against the mouthpiece by the bracket; and
a reed guard configured for being placed into a guarded position so as to be located over at least a portion of the reed in order to protect the portion of the reed from damage, wherein the reed guard is capable of being pivoted with respect to the mouthpiece.

2. The reed guard assembly as set forth in claim 1, wherein the reed guard is pivotally attached to the bracket and is capable of being positioned such that a portion of the reed is located between the reed guard and the mouthpiece.

3. The reed guard assembly as set forth in claim 1, further comprising a thumb screw, and wherein the bracket has a first protrusion and a second protrusion extending therefrom, wherein the first protrusion has a first aperture and wherein the second protrusion has a second aperture that is in alignment with the first aperture, wherein the reed guard has a mounting bracket that has a mounting bracket aperture, wherein the thumb screw is inserted through the first aperture, the second aperture, and the mounting bracket aperture so as to effect pivotal attachment of the reed guard to the first protrusion, and so as to effect attachment of the bracket to the mouthpiece.

4. The reed guard assembly as set forth in claim 3, further comprising a second thumb screw, and wherein the bracket has a third protrusion and a fourth protrusion extending therefrom, wherein the third protrusion has a third aperture and wherein the fourth protrusion has a fourth aperture that is in alignment with the third aperture, wherein the second thumb screw is inserted through the third aperture and the fourth aperture so as to effect attachment of the bracket to the mouthpiece, wherein a portion of the reed is not located between the bracket and the mouthpiece and extends towards the tail of the mouthpiece.

5. The reed guard assembly as set forth in claim 1, wherein the reed guard is capable of being pivoted into an unguarded position in which the reed guard does not cover any portion of the reed that extends from the bracket to the tip of the mouthpiece.

6. The reed guard assembly as set forth in claim 5, wherein when the reed guard is in the unguarded position the reed guard extends beyond an end of the reed that is closest to the tail of the mouthpiece.

7. The reed guard assembly as set forth in claim 1, wherein the reed guard has an elongated portion, and wherein when the reed guard is placed into the guarded position the elongated portion extends beyond an end of the reed that is closest to the tip of the mouthpiece.

8. The reed guard assembly as set forth in claim 1, wherein the reed guard contacts the reed when the reed guard is placed into the guarded position.

9. The reed guard assembly as set forth in claim 1, wherein when the reed guard is placed into the guarded position the reed guard extends beyond but does not cover the sides of the reed that extend from the bracket to the tip of the mouthpiece.

10. A reed guard assembly, comprising:
a mouthpiece;
a reed; and
a reed guard carried by the mouthpiece and configured for being placed into a guarded position so as to protect at least a portion of the reed, wherein the mouthpiece is configured for being placed into an unguarded position so as to not protect the portion of the reed protected in the guarded position, wherein the reed guard is carried by the mouthpiece when in the unguarded position.

11. The reed guard assembly as set forth in claim 10, further comprising a bracket that engages the mouthpiece and holds the reed against the mouthpiece, wherein the reed guard is attached to the bracket so that the reed guard is carried by the mouthpiece.

12. The reed guard assembly as set forth in claim 11, wherein the reed guard is pivotally attached to the bracket.

13. The reed guard assembly as set forth in claim 11, wherein when the reed guard is placed into the unguarded position the reed guard does not cover any portion of the reed that extends from the bracket to a tip of the mouthpiece.

14. The reed guard assembly as set forth in claim 11, further comprising a thumb screw, and wherein the bracket has a first protrusion and a second protrusion extending therefrom, wherein the first protrusion has a first aperture and wherein the second protrusion has a second aperture that is in alignment with the first aperture, wherein the reed guard has a mounting bracket that has a mounting bracket aperture, wherein the thumb screw is inserted through the first aperture, the second aperture, and the mounting bracket aperture so as to effect pivotal attachment of the reed guard to the first protrusion, and so as to effect attachment of the bracket to the mouthpiece.

15. The reed guard assembly as set forth in claim 11, wherein when the reed guard is placed into the guarded position the reed guard extends beyond but does not cover the sides of the reed that extend from the bracket to a tip of the mouthpiece.

16. The reed guard assembly as set forth in claim 10, wherein a portion of the reed is located between the reed guard and the mouthpiece when the reed guard is placed into the guarded position.

17. The reed guard assembly as set forth in claim 10, wherein when the reed guard is placed into the unguarded position the reed guard extends beyond an end of the reed that is closest to a tail of the mouthpiece.

18. The reed guard assembly as set forth in claim 10, wherein the reed guard has an elongated portion, and wherein when the reed guard is placed into the guarded position the elongated portion extends beyond an end of the reed that is closest to a tip of the mouthpiece.

19. The reed guard assembly as set forth in claim 10, wherein the reed guard contacts the reed when the reed guard is placed into the guarded position.

20. A reed guard assembly for a musical instrument, comprising:
a mouthpiece having a tip, a middle section, and a tail, wherein an air duct is defined through the mouthpiece that extends from the tip through the middle section to the tail;
a bracket attached to the mouthpiece;
a reed held against the mouthpiece by the bracket; and
a reed guard configured for being placed into a guarded position so as to be located over at least a portion of the reed in order to protect the portion of the reed from damage, wherein when in the guarded position an elongated portion of the reed guard extends beyond an end of the reed that is closest to the tip of the mouthpiece, wherein the reed guard has a mounting bracket aperture and it pivotally connected to the bracket so as to be pivotal from the guarded position to an unguarded position, wherein the reed guard is connected to the bracket when the reed guard is in the unguarded position.
